(19) United States
(12) Patent Application Publication
(10) Pub. No.: US 2011/0063418 A1
(43) Pub. Date: Mar. 17, 2011

(54) Integrated Mount and Control Device for Stereoscopic Video

(76) Inventor: Matthew A. Parker, San Diego, CA (US)

(21) Appl. No.: 12/850,624

(22) Filed: Aug. 4, 2010

Related U.S. Application Data
(60) Provisional application No. 61/231,314, filed on Aug. 4, 2009.

(51) Int. Cl. H04N 13/02; H04N 13/00

(52) U.S. Cl. 348/47; 348/42; 348/E13.001; 348/E13.074

(57) ABSTRACT

A device is described which allows convenient acquisition of stereoscopic video. In accordance with one embodiment, a rigid mounting bar is provided on which two camcorders can be mounted. The bar has mounting slots or other means to provide for adjustment of the distance between the two cameras. An electronic synchronization and control circuit is contained within the mounting bar. This circuit synchronizes the two camcorders quickly so that each video frame is acquired simultaneously by the two camcorders.

### RELATED APPLICATION DATA

This application claims the benefit of provisional patent application Ser. No. 61/231,314, filed 2009 Aug. 4 by the present inventor.

### FIELD OF THE INVENTION

The invention relates generally to apparatus for acquiring stereoscopic (3-D) video, and more particularly to a combination mount and control device usable in conjunction with camcorders, video cameras, or other image acquisition devices to acquire stereoscopic video.

### BACKGROUND AND PRIOR ART

The following is a tabulation of some prior art that presently appears relevant:

U.S. Patents

| Patent Number | Issue Date | Patentee |
|---|---|---|
| 2,400,455 | 1946 May 14 | Donaldson |
| 2,893,303 | 1959 Jul. 07 | Geraci |
| 4,943,852 | 1990 Jul. 24 | Femano et al. |
| 5,963,369 | 1999 Oct. 05 | Steinthal et al. |

U.S. Patent Application Publications

| Publication Nr. | Publ. Date | Applicant |
|---|---|---|
| 2008/0024596 | 2008 Jan. 31 | Li et al. |

### NONPATENT LITERATURE DOCUMENTS

Vrancic, D. et al. “Permanent synchronization of camcorders via LANC protocol.” Stereoscopic Displays and Virtual Reality Systems XIII, Proceedings of the SPIE Volume 6055 (16-19 Jan. 2006, San Jose, Calif.).

Stereoscopic (3-D) photography has been in existence since the early days of photography in the mid-nineteenth century. In one implementation, two or more cameras are mounted a certain distance apart to capture the stereo images simultaneously. In another implementation, a minor or beamsplitter generates at least two simultaneous images using a single camera. In another implementation, a mechanical apparatus generates at least two sequential images from a single camera by moving it to one side after capturing the first image to capture one or more additional images. For example Donaldson (1946) teaches a mount design for 3-D photography using a displaced single camera. Geraci (1959) teaches another mount design for using a displaced single camera. The mounts described in these two references can be used only for still photography.

Stereoscopic video is acquired in similar ways as stereoscopic still photography. Femano et al. (1990) teach using an optical apparatus containing beam splitters to route two images to a single 2-D video camera. This approach has the disadvantage of limiting the resolution to half that of a single camera.

If the video is to be acquired with two or more cameras, synchronization between the cameras is absolutely required for good stereoscopic video. Steinthal et al. (1999) teach incorporation of recording and synchronization circuitry into binoculars, allowing the recording of 3-D video. This is a specialized approach for magnified distant scenes and is not well suited for general use. Li et al. (2008) teach incorporation of two video sensors, memory, a diversity combine module, and encoder into the same device. This approach has the disadvantage of requiring complex and expensive circuitry to encode the 3-D video data in real time.

Vrancic et al. (2006) teach a device in which external circuits in a box are used to achieve synchronization and simultaneous zoom control of two camcorders. However, this approach has the following several disadvantages: the described circuits are bulky; a separate battery or other power source is required; synchronization is slow because of the use of a voltage-controlled crystal oscillator; and the circuits are housed in an unwieldy box separate from the camera mount.

### SUMMARY OF THE INVENTION

In accordance with one embodiment, a rigid mounting bar is provided on which two camcorders can be mounted. The bar has mounting slots or other means to provide for adjustment of the distance between the two cameras. An electronic synchronization and control circuit is contained within the mounting bar. This circuit synchronizes the two camcorders quickly so that each video frame is acquired simultaneously by the two camcorders.

### BRIEF DESCRIPTION OF THE DRAWINGS

FIG. 1 shows a schematic of the synchronization and zoom control circuit.

FIG. 2 shows the outline and top copper traces of a circuit board on which components of one embodiment are mounted.

FIG. 3 shows the outline and bottom copper traces of a circuit board on which components of one embodiment are mounted.

FIG. 4 shows the top view of a rigid bar in which the control and synchronization circuit of one embodiment is mounted.

FIG. 5 shows the front view of a rigid bar in which the control and synchronization circuit of one embodiment is mounted.

FIG. 6 shows the bottom view of a rigid bar in which the control and synchronization circuit of one embodiment is mounted.

### DESCRIPTION OF INVENTION

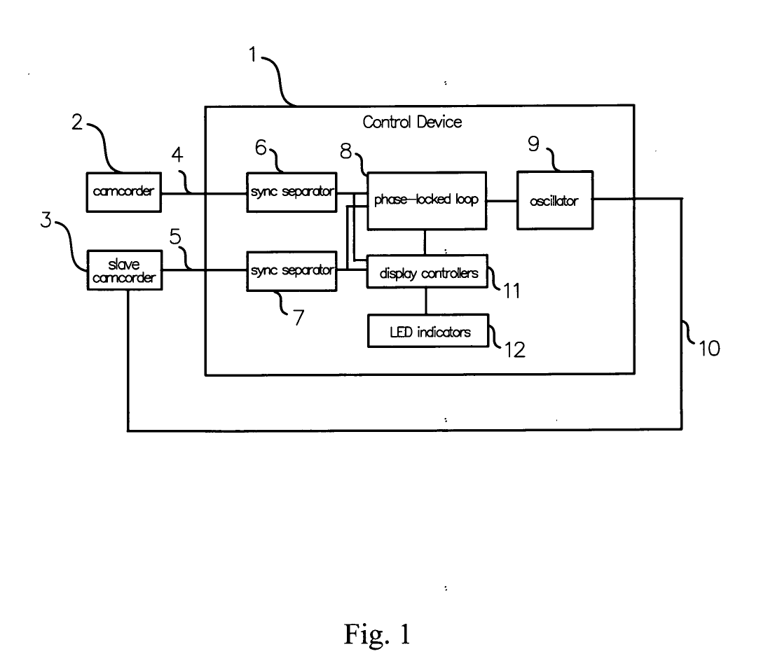

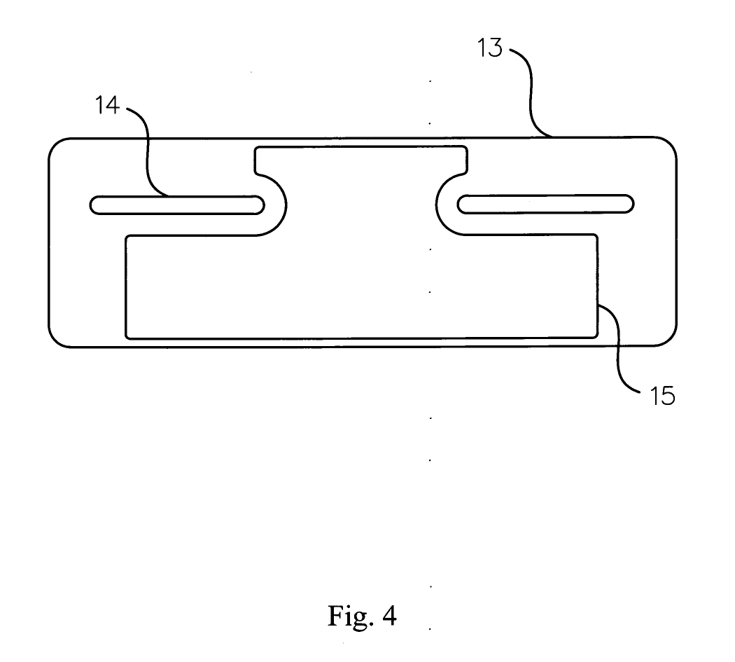

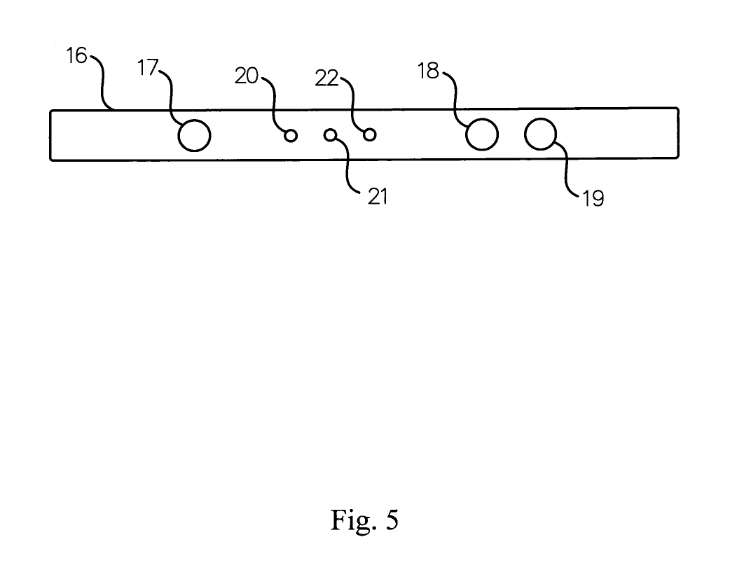

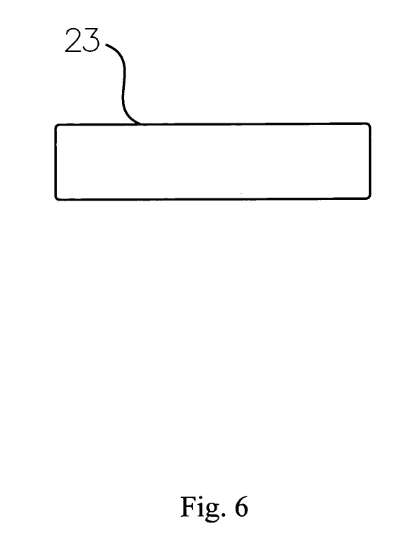

One embodiment of the device is shown in FIGS. 1 through 6. In this embodiment, an electronic synchronization circuit is contained within a rigid camera mounting bar. FIG. 1 shows the electronic schematic of the circuit. The circuit monitors the difference in time between video frames of the two camcorders and quickly synchronizes the camcorders by adjusting the frame rate of one of the camcorders until it is in sync with the other. One of the two cameras is able to accept an external oscillator signal for the purposes of synchronization. The circuit is contained within the mounting bar shown in FIGS. 4-6. The electronic circuit also controls the zoom and/or focus of the camcorders and provides for simultaneous zoom and/or focus.

This embodiment of the present invention is superior to prior art in at least two ways: First, it achieves very fast synchronization. It does so by using a voltage-controlled oscillator with a varactor as part of a resonant inductance-capacitance circuit. This allows a wide range of frequency adjustment, which in turn results in fast synchronization. Second, the electronic circuit is quite small and is situated inside a rigid mounting bar. This achieves convenience and portability of the system by combining two system components into one.

FIG. 1 shows a schematic of the synchronization and zoom control circuit in one embodiment. Video input from the camcorders is processed by video sync separators IC2 and IC3. The signal phase is compared by phase-locked loop IC5. The PLL control signal is buffered by op amp IC6 and controls the capacitance of varactor D2. Varactor D2 is part of the LC resonant tank circuit of oscillator JFET Q1. Thus the PLL control signal controls the frequency of oscillator Q1. The signal from Q1 is buffered by IC11 and multiplied/divided by IC12 to give the final clock frequency for control of the modified, or slave, camcorder. The signal is output to RCA jack J3_OSC and from there it is connected by cable to the slave camcorder. IC7, IC8, IC9, and IC10 control the indicator LEDs which indicate whether video signal is present from the camcorders and whether sync has been achieved. IC15 is a microcontroller which acts as a LANC interface to the camcorders and the attached LANC remote, allowing simultaneous zoom and/or focus control of the two camcorders. Jacks J1_1, J1_M, and J1_R connect to the left camcorder, LANC remote, and right camcorder, respectively. IC4, IC13, and IC17 are voltage regulator circuits. The entire circuit is powered by the two camcorders' batteries and no separate battery or other external power supply is required.

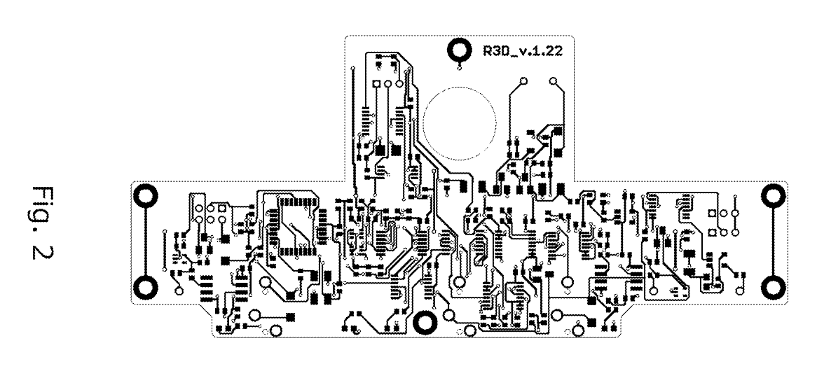

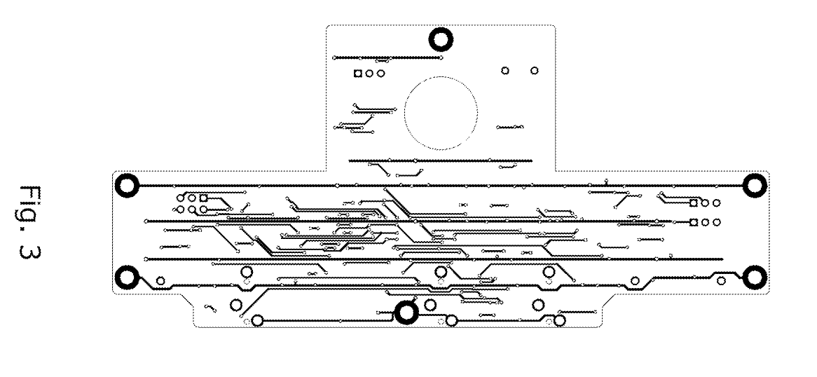

FIGS. 2 and 3 show the top and bottom copper traces, respectively, of the circuit board on which components are mounted in this embodiment. The overall dimensions of the circuit board are 4.5 inches by 2.07 inches by 0.062 inches. FIGS. 4, 5, and 6 show the top, front, and left views, respectively, of the rigid bar in which the circuit is mounted in this embodiment. The cutout is just the right size to accommodate the circuit board of FIGS. 2 and 3. Not shown are two aluminum cover plates which fit into the top and bottom of the rigid bar and provide a flat exterior surface. Slots visible toward the top of the top view in FIG. 4 are used for mounting the two cameras using machine screws from the bottom side. The width of the slots allows varying the camera-to-camera distance.

In another embodiment of the invention, a rigid bar and a synchronization circuit are present without a circuit for simultaneous zoom or focus control. In yet another embodiment, a rigid bar and a zoom or focus control are present without a synchronization circuit.

In this or other embodiments, a bar of wood, plastic, or metal may serve as the camera mount.

In other embodiments, a synchronization circuit may employ a means of synchronization other than a phase-locked loop.

In other embodiments, a zoom control circuit may be present without focus control, or a focus control circuit may be present without zoom control.

In other embodiments, the video acquisition devices may be video cameras, specialized charge-coupled devices, or other image acquisition devices with or without storage capability.

In other embodiments, provision may be made for mounting and control of more than two cameras or other image acquisition devices.

I claim:

1. An integrated mount and control device for acquiring stereoscopic video comprising:
a. a bar on which two or more video acquisition devices can be mounted, and
b. a control circuit for said video acquisition devices.

2. The device of claim 1 wherein said control circuit is enclosed within said bar.

3. The device of claim 1 wherein said control circuit is mounted on the exterior of said bar.

4. The device of claim 1 wherein said video acquisition devices are camcorders.

5. The device of claim 1 wherein said control circuit synchronizes said video acquisition devices.

6. The device of claim 1 wherein said control circuit controls zoom of said video acquisition devices.

7. The device of claim 1 wherein said control circuit controls focus of said video acquisition devices.

8. The device of claim 1 wherein said control circuit synchronizes and controls focus of said video acquisition devices.

9. The device of claim 1 wherein said control circuit synchronizes and controls zoom of said video acquisition devices.

10. The device of claim 1 wherein said control circuit synchronizes, controls focus, and controls zoom of said video acquisition devices.
